(19) United States
(12) Patent Application Publication
(10) Pub. No.: US 2007/0073784 A1
(43) Pub. Date: Mar. 29, 2007

(54) System and method for type inheritance for content management

(75) Inventors: Ryan Sean McVeigh, Broomfield, CO (US); Steven L. Roth, Westminster, CO (US); Jalpesh Patadia, Boulder, CO (US); Tanya Saarva, Boulder, CO (US); Xiaojiang Zhou, Broomfield, CO (US); Brad Posner, Erie, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/438,202

(22) Filed: May 22, 2006

Related U.S. Application Data
(60) Provisional application No. 60/720,860, filed on Sep. 26, 2005.

(51) Int. Cl. G06F 17/30

(52) U.S. Cl. 707/200

(57) ABSTRACT

In accordance with embodiments, there are provided mechanisms and methods for type inheritance in a content management system. These mechanisms and methods for type inheritance in a content management system can enable users to create types that extend from another type rather than create from scratch. The ability of embodiments to provide create types that extend from another type can enable a child type to automatically inherit one or more property definitions as defined in a parent type. For example, a user can create a type clothing with property definitions such as color, size, etc. The user can then create another type shirt, which “extends” the clothing type. Embodiments may further provide the ability to have abstract types, nested types and link property types.

### CLAIM OF PRIORITY

This application claims the benefit of U.S. Provisional Patent Application 60/720,860 entitled IMPROVED CONTENT MANAGEMENT, by Ryan McVeigh et al., filed Sep. 26, 2005 (Attorney Docket No. BEAS-01968US0), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. patent application Ser. No. ______ entitled SYSTEM AND METHOD FOR TYPE INHERITANCE FOR CONTENT MANAGEMENT, by Ryan McVeigh et al., filed on May ______, 2006, Attorney Docket No. BEAS-1879US0;

U.S. patent application Ser. No. ______ entitled SYSTEM AND METHOD FOR PROVIDING NESTED TYPES FOR CONTENT MANAGEMENT, by Ryan McVeigh et al., filed on May ______, 2006, Attorney Docket No. BEAS-1880US0; and

U.S. patent application Ser. No. ______ entitled SYSTEM AND METHOD FOR PROVIDING LINK PROPERTY TYPES FOR CONTENT MANAGEMENT, by Ryan McVeigh et al., filed on May ______, 2006, Attorney Docket No. BEAS-1881US0.

### FIELD OF THE INVENTION

The current invention relates generally to managing content for use with portals and other content delivery mechanisms, and more particularly to mechanisms for type inheritance, abstract types, nested types and link property types in a content management system.

### BACKGROUND

Content repositories manage and provide access to large data stores such as a newspaper archives, advertisements, inventories, image collections, etc. A content repository can be a key component of a web application such as a portal, which must quickly serve up different types of content in response to user interaction. However, difficulties can arise when trying to integrate more than one vendor's content repository. Each may have its own proprietary application program interface and content services (e.g., conventions for searching and manipulating content, versioning, workflows, and data formats). Furthermore, each time a repository is added to an application, the application software must be modified to accommodate these differences. What is needed is a coherent system and method for interacting with disparate repositories and for providing a uniform set of content services across all repositories, including those that lack such services.

### BRIEF DESCRIPTION OF THE DRAWINGS

FIG. 1 is an exemplary illustration of functional system layers in various embodiments.

FIG. 2 is an exemplary illustration of objects/interfaces that can be used to interface repositories comprising content in various embodiments.

FIGS. 3A-3C are operational flow diagrams illustrating a high level overview of techniques for type inheritance, nested types and link property types in a content management system in embodiments.

FIGS. 4A-4B are data diagram illustrating database fields and relationships supporting techniques for type inheritance, nested types and link property types in embodiments.

FIG. 5 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for type inheritance in a content management system. These mechanisms and methods for type inheritance in a content management system can enable users to create types that extend from another type rather than create from scratch. The ability of embodiments to provide create types that extend from another type can enable a child type to automatically inherit one or more property definitions as defined in a parent type. For example, a user can create a type clothing with property definitions such as color, size, etc. The user can then create another type shirt, which “extends” the clothing type by adding a “sleeve length” property definition. Embodiments may further provide the ability to have abstract types, nested types and link property types.

In an embodiment and by way of example, a method for type inheritance in a content management system is provided. One method embodiment includes receiving a definition of a child data type, the child data type based upon a parent data type. At least one node in a virtual content repository (VCR) can be determined from the definition of a child data type. The node corresponds to the child data type and has at least one relationship with at least one other node. The at least one relationship can support extension of at least one property by the child data type from the parent data type. The at least one other node corresponds to the parent data type. The VCR models content in a plurality of content repositories. Content in the plurality of content repositories can then be managed based upon the VCR. In the event that either of the child data type or the parent data types are abstract data types, instantiation of any nodes based upon the abstract data type is blocked. The notion of a type being inherited can be made transparent to content nodes in embodiments.

In another aspect and according to embodiments, there are provided mechanisms and methods for providing nested variables in a content management system. These mechanisms and methods for providing nested variables in a content management system can enable users to model types that can be used within other type definitions. This differs from the Type Inheritance feature in that types that make use of the nested type feature do not extend their functionality but define a property definition having a value defined by all property definitions in the nested type. For example, user can create a type address with property definitions such as street, city, zip code, etc. The user can then create another type person that has property definitions such as “name” and home address and business address. The two address property definitions can be represented by the address type, each with the address type's property definitions.

In an embodiment and by way of example, a method for providing nested types in a content management system is provided. One method embodiment includes receiving definitions of a first data type and a second data type, the second data type based upon the first data type. At least one node is determined from the definition of the second data type in a virtual content repository (VCR) that models content in a plurality of content repositories. The at least one node corresponds to the second data type and has at least one relationship with at least one other node. The at least one other node corresponds to the first data type. The at least one relationship corresponds to defining a property of the first data type having a value defined by property definitions in the second data type. Content in the plurality of content repositories can then be managed based upon the VCR.

In a yet further aspect and according to embodiments, there are provided mechanisms and methods for providing linked property types in a content management system. These mechanisms and methods for providing linked property types in a content management system can enable users to specify a new property definition type, which refers to another node instance in the content management system. By specifying a link property definition type on a type, the user can then relate a node instance of the modeled type (link source) to any other node instance (link target) in the system. For example, a user can create a type Article with property definitions such as title, body and authorLink. The authorLink property definition can be a link type property definition. Then the user could define an Author content type. When an instance of an Article is created (anArticle), the authorLink property associated with anArticle could refer to a node instance of an Author.

In an embodiment and by way of example, a method for providing linked property types in a content management system is provided. One method embodiment includes receiving a link property definition type comprising a property definition type that refers to at least one node instance (“link target”) in the content management system. At least one node (“link source”) is determined from the definition of the link property definition type in a virtual content repository (VCR) that models content in a plurality of content repositories. The at least one node corresponds to the link property definition type and has at least one relationship with the at least one node instance. The at least one node instance corresponds to the link target. The at least one relationship supports relating the at least one node of the link source to the at least one node instance of the link target. Content in the plurality of content repositories can then be managed based upon the VCR.

As used herein, the term inheritance (or extension) is defined as when an object extends or inherits from a parent object, it gains the functionality as described by that parent object. The object is also capable of modifying that functionality to suit the object's specific needs. For content types, the functionality that can be extended and/or modified is the parent type's property definitions. As used herein, the term subtype is defined as a content type that has extended another content type. This is typically the child in the parent-child relationship. As used herein, the term Supertype (or Base Type) is defined as a content type that has been extended by another content type. This is typically the parent in the parent-child relationship. As used herein, the term overload is defined as the process by which a user modifies a property definition specified by a supertype. As used herein, the term abstract type is defined as a type that cannot be “instantiated”. A user cannot create a node of an abstract type. An abstract type may serve to be extended by other types (which could then have nodes instantiated) or a nested type within another type. As used herein, the term container type is defined as a type that contains other types as part of its data model. As used herein, the term contained type is defined as a type that is modeled within another type. This is done by the container type creating a property definition of type “nested type” which refers to the type to be nested. As used herein, the term container instance is defined as a node that is an instance of a container type. As used herein, the term contained instance is defined as a “node” that represents the property values of the nested property type within a container node. As used herein, the term link property type is defined as type of property definition that specifies a link to another node in the content management system. As used herein, the term link source is defined as the node containing the link property type property. As used herein, the term link target is defined as the target node to which a link source node's link property refers. Multiple link source nodes may reference the same target node. Further, link sources can target multiple link target nodes.

While the present invention is described with reference to an embodiment in which techniques for type inheritance, abstract types, nested types and link property types in a content management system are implemented in an application server in conformance with the J2EE Management Framework using executable programs written in the Java™ programming language, the present invention is not limited to the J2EE Management Framework nor the Java™ programming language. Embodiments may be practiced using other interconnectivity specifications or programming languages, i.e., JSP and the like without departing from the scope of the embodiments claimed. (Java™ is a trademark of Sun Microsystems, Inc.).

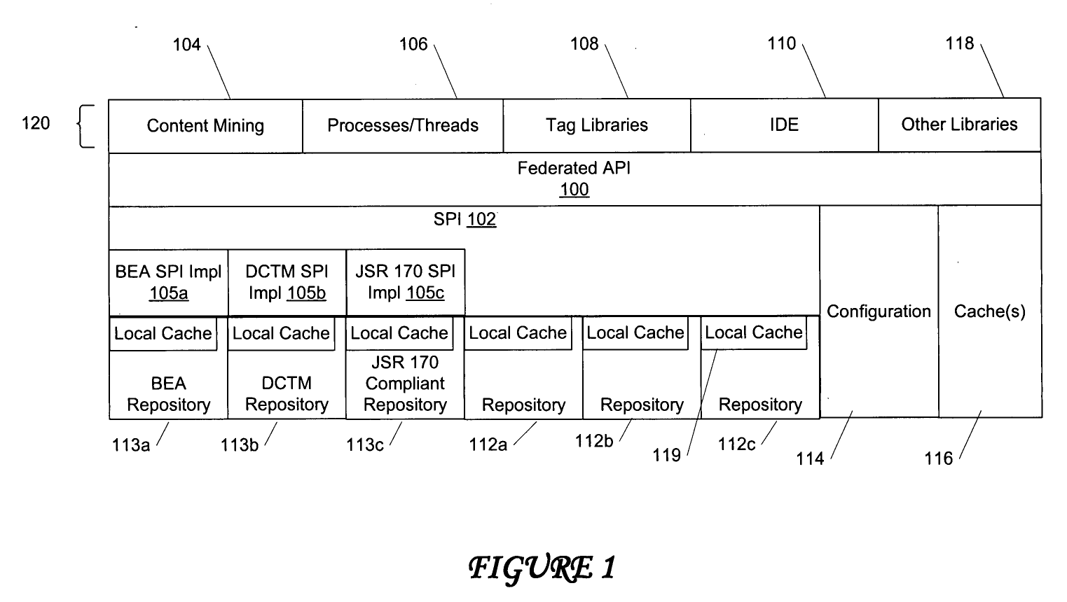

FIG. 1 is an exemplary illustration of functional system layers in various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A content repository 112 represents a searchable data store. Such systems can relate structured content and unstructured content (e.g., digitally scanned paper documents, Extensible Markup Language, Portable Document Format, Hypertext Markup Language, electronic mail, images, video and audio streams, raw binary data, etc.) into a searchable corpus. Content repositories can be coupled to or integrated with content management systems. Content management systems can provide for content workflow management, versioning, content review and approval, automatic content classification, event-driven content processing, process tracking and content delivery to other systems. By way of illustration, if a user fills out a loan application on a web portal, the portal can forward the application to a content repository which, in turn, can contact a bank system, receive notification of loan approval, update the loan application in the repository and notify the user by rendering the approval information in a format appropriate for the web portal.

A virtual or federated content repository (hereinafter referred to as “VCR”) is a logical representation of one or more individual content repositories. For example, the VCR provides a single access point to multiple repositories from the standpoint of application layer 120 but does not shield from the user that there is more than one repository available. The VCR can also add content services to repositories that natively lack them. Typically, the user interacts with the VCR by specifying which repository an action is related to (such as adding a new node), or performing an action that applies to all repositories (such as searching for content). In various embodiments and by way of illustration, this can be accomplished in part by use of an API (application program interface) 100 and an SPI (service provider interface) 102. An API describes how entities in the application layer can interface with some program logic or functionality. The application layer can include applications (and subdivisions thereof) that utilize the API, such as processes, threads, servlets, portlets, objects, libraries, and other suitable application components. An SPI describes how a service provider (e.g., a content repository, a content management system) can be integrated into a system of some kind. The SPI isolates direct interaction with repositories from the API. In various embodiments, this can be accomplished at run-time wherein the API library dynamically links to or loads the SPI library. In another embodiment, the SPI can be part of a server process such that the API and the SPI can communicate over a network. The SPI can communicate with the repositories using any number of means including, but not limited to, shared memory, remote procedure calls and/or via one or more intermediate server processes.

Content repositories may comprise a variety of interfaces for connecting with the repository. For example, as shown in FIG. 1, a BEA format repository 113a provided by BEA Systems, Inc. of San Jose, Calif., a Documentum format repository 113b, provided by EMC Corp. of Hopkinton, Mass., and a JSR-170 compliant repository 113c may be integrated into a VCR and made accessible via a single federated API 100 by SPI 102. Individual SPI implementations 105a, 105b, 105c provide format specific service provider interfaces to the BEA format repository 113a, the Documentum format repository 113b, and the JSR-170 format repository 113c, respectively. It is noteworthy that not all of the formats illustrated in FIG. 1 will be present in all embodiments. Further, some embodiments will include other repository formats not illustrated by FIG. 1 for brevity.

API's and SPI's can be specified as a collection of classes/interfaces, data structures and/or methods/functions that work together to provide a programmatic means through which VCR service(s) can be accessed and utilized. By way of illustration, APIs and SPIs can be specified in an object-oriented programming language, such as Java™ (available from Sun Microsystems, Inc. of Mountain View, Calif.) and C# (available from Microsoft Corp. of Redmond, Wash.). The API and SPI can be exposed in a number of ways, including but not limited to static libraries, dynamic link libraries, distributed objects, servers, class/interface instances, and other suitable means.

In various embodiments, the API presents a unified view of all repositories to the application layer such that navigation, CRUD operations (create, read, update, delete), versioning, workflows, and searching operations initiated from the application layer operate on the repositories as though they were one. Repositories that implement the SPI can “plug into” the VCR. The SPI includes a set of interfaces and services that support API functionality at the repository level. The API and SPI share a content model that represents the combined content of all repositories as a hierarchical namespace of nodes. Given a node N, nodes that are hierarchically inferior to N are referred to as children of N, whereas nodes that are hierarchically superior to N are referred to as parents of N. The top-most level of the hierarchy is termed the federated root. There is no limit to the depth of the hierarchy. In various embodiments, repositories are children of the federated root. Each repository can itself have children.

By way of illustration, content mining facilities 104, processes/threads 106, tag libraries 108, integrated development environments (IDEs) 110, and other libraries 118 can all utilize the API to interact with a VCR. An IDE can provide the ability for a user to interactively build workflows and/or content views. Content mining facilities can include services for automatically extracting content from the VCR based on parameters. Java ServerPages™ tag libraries enable portals to interact with the VCR and surface its content on web pages. (Java ServerPages™ is available from Sun Microsystems, Inc.) In addition, it will be apparent to those of skill in the art that many other types of applications and software components utilize the API and are, as such, fully within the scope and spirit of the present disclosure.

In various embodiments, the API can include optimizations to improve the performance of interacting with the VCR. One or more caches 116 can be used to buffer search results and/or recently accessed nodes. Some implementations may include additional cache 119 in one or more repositories. In various embodiments, a cache can include a node cache and/or a binary cache. A node cache can be used to provide fast access to recently accessed nodes whereas a binary cache can be used to provide fast access to the content/data associated with each node in a node cache. The API can also provide a configuration facility 114 to enable applications, tools and libraries to configure caches and the VCR. In various embodiments, this facility can be can be configured via Java Management Extension (JMX) (available from Sun Microsystems, Inc.).

In various embodiments, a model for representing hierarchy information, content and data types is shared between the API and the SPI. In this model, a node can represent hierarchy information, content or schema information. Hierarchy nodes can serve as containers for other nodes in the namespace akin to a file subdirectory in a hierarchical file system. Schema nodes represent predefined data types. Content nodes represent content/data. Nodes can have a shape defined by their properties. A property associates a name, a data type and an optional a value that is appropriate for the type. In certain of these embodiments, the properties of content nodes contain values. By way of an illustration, a type can be any of the types described in Table 1. Those of skill in the art will appreciate that many more types are possible and fully within the scope and spirit of the present disclosure.

TABLE 1
Exemplary Property Types in Various Embodiments

| PROPERTY | |
|---|---|
| TYPE | DESCRIPTION |
| Basic | Text, a number, a date/time, a Boolean value, a choice, an |
| | image, a sound, a bit mask, an audio/visual presentation, |
| | binary data. |
| Link | A pointer/reference to data that lives “outside” of a node. |
| Lookup | An expression to be evaluated for locating another node |
| | in the VCR |
| Database | Maps to an existing database table or view. |
| Mapped (or | |
| schema) | |
| Nested | One or more schemas define individual properties. |

In various embodiments, a property can also indicate whether it is required, whether it is read-only, whether it provides a default value, and whether it specifies a property choice. A property choice indicates if a property is a single unrestricted value, a single restricted value, a multiple unrestricted value, or a multiple restricted value. Properties that are single have only one value whereas properties that are multiple can have more than one value. If a property is restricted, its value(s) are chosen from a finite set of values. But if a property is unrestricted, any value(s) can be provided for it. A property can also be designated as a primary property. By way of illustration, the primary property of a node can be considered its default content. For example, if a node contained a binary property to hold an image, it could also contain a second binary property to represent a thumbnail view of the image. If the thumbnail view was the primary property, software applications such as browser could display it by default.

A named collection of one or more property types is a schema. A schema node is a place holder for a schema. In various embodiments, schemas can be used to specify a node's properties. By way of illustration, a Person schema with three properties (Name, Address and DateofBirth) can be described for purposes of discussion as follows:

Schema Person = {

<Name=Name, Type=Text>,
<Name=Address, Type=Address>,
<Name=DateofBirth, Type=Date>}

Various embodiments allow a node to be defined based on a schema. By way of illustration, a content node John can be given the same properties as the schema Person:

Content Node John is a Person

In this case, the node John would have the following properties: Name, Address and DateofBirth. Alternatively, a node can use one or more schemas to define individual properties. This is sometimes referred to as nested types. In the following illustration, John is defined having an Info property that itself contains the properties Name, Address and DateofBirth. In addition, John also has a CustomerId property:

Content Node John = {

<Name=Info, Type=Person>,
<Name=CustomerId, Type=Number> }

Schemas can be defined logically in the VCR and/or in the individual repositories that form the VCR. In certain embodiments, schemas can inherit properties from at least one other schema. Schema inheritance can be unlimited in depth. That is, schema A can inherit from schema B, which itself can inherit from schema C, and so on. If several schemas contain repetitive properties, a “base” schema can be configured from which the other schemas can inherit. For example, a Person schema containing the properties Name, Address and DateofBirth, can be inherited by an Employee schema which adds its own properties (i.e., Employee ID, Date of Hire and Salary):

Schema Employee inherits from Person = {

<Name=EmployeeID, Type= Number>,
<Name=DateofHire, Type=Date>,
<Name=Salary, Type= Number> }

Thus, as defined above the Employee schema has the following properties: Name, Address, DateofBirth, EmployeeID, DateofHire and Salary. If the Person schema had itself inherited properties from another schema, those properties would also belong to Employee.

In various embodiments, nodes have names/identifiers and can be specified programmatically or addressed using a path that designates the node's location in a VCR namespace. By way of illustration, the path can specify a path from the federated root (‘/’) to the node in question (‘c’):

/a/b/c

In this example, the opening ‘/’ represents the federated root, ‘a’ represents a repository beneath the federated root, ‘b’ is a hierarchy node within the ‘a’ repository, and ‘c’ is the node in question. The path can also identify a property (“property1”) on a node:

/a/b/c.property1

In aspects of these embodiments, the path components occurring prior to the node name can be omitted if the system can deduce the location of the node based on context information.

In various embodiments, a schema defined in one repository or the VCR can inherit from one or more schemas defined in the same repository, a different repository or the VCR. In certain aspects of these embodiments, if one or more of the repositories implicated by an inherited schema do not support inheritance, the inheriting schema can be automatically defined in the VCR by the API. In one embodiment, the inheriting schema is defined in the VCR by default.

By way of illustration, the Employee schema located in the Avitech repository inherits from the Person schema located beneath the Schemas hierarchy node in the BEA repository:

Schema /Avitech/Employee inherits from /BEA/Schemas/Person = {

<Name=EmployeeID, Type= Number>,
<Name=DateofHire, Type=Date>,
<Name=Salary, Type= Number> }

In various embodiments, the link property type (see Table 1) allows for content reuse and the inclusion of content that may not be under control of the VCR. By way of illustration, the value associated with a link property can refer/point to any of the following: a content node in a VCR, an individual property on a content node in a VCR, a file on a file system, an object identified by a URL (Uniform Resource Locator), or any other suitable identifier. In various embodiments, when editing a content node that has a link property type, a user can specify the link destination (e.g., using a browser-type user interface). In certain aspects of these embodiments, if a link refers to a content node or a content node property that has been moved, the link can be resolved automatically by the system to reflect the new location.

In various embodiments, a value whose type is lookup (see Table 1) can hold an expression that can be evaluated to search the VCR for instances of content node(s) that satisfy the expression. Nodes that satisfy the expression (if any) can be made available for subsequent processing. In various embodiments, a lookup expression can contain one or more expressions that can substitute expression variables from: the content node containing the lookup property, a user profile, anything in the scope of a request or a session. In various embodiments, an expression can include mathematical, logical and Boolean operators, function/method invocations, macros, SQL (Structured Query Language), and any other suitable query language. In various embodiments, an expression can be pre-processed one or more times to perform variable substitution, constant folding and/or macro expansion. It will be apparent to those of skill in the art that many other types of expressions are possible and fully within the scope and spirit of this disclosure.

In various embodiments, when editing a content node that has a lookup property type, the user can edit the expression through a user interface that allows the user to build the expression by either entering it directly and/or by selecting its constituent parts. In addition, the user interface can enable the user to preview the results of the expression evaluation.

Database mapped property types (see Table 1) allow information to be culled (i.e., mapped) from one or more database tables (or other database objects) and manipulated through node properties. By way of illustration, a company might have “content” such as news articles stored as rows in one or more RDBMS (Relational Database Management System) tables. The company might wish to make use of this “content” via their portal implementation. Further, they might wish to manage the information in this table as if it existed in the VCR. Once instantiated, a content node property that is of the database mapped type behaves as though its content is in the VCR (rather than the database table). In one embodiment, all API operations on the property behave the same but ultimately operate on the information in the database table.

In various embodiments, a given database mapped property type can have an expression (e.g., SQL) which, when evaluated, resolves to a row and a column in a database table (or resolves to any kind of database object) accessible by the system over one or more networks. A database mapped property will be able to use either native database tables/objects or database views on those tables/objects. It will be appreciated by those of skill in the art that the present disclosure is not limited to any particular type of database or resolving expression.

In aspects of certain embodiments, a schema can be automatically created that maps to any row in a database table. The system can inspect the data structure of the table and pre-populate the schema with database mapped properties corresponding to columns from the table. The table column names can be used as the default property names and likewise the data type of each column will determine the data type of each corresponding property. The system can also indicate in the schema which properties correspond to primary key columns. If certain columns from the table are not to be used in the new schema, they can be un-mapped (i.e. deselected) by a user or a process. A content node can be based on such a schema and can be automatically bound to a row in a database table (or other database object) when it is instantiated. In various embodiments, a user can interactively specify the database object by browsing the database table.

While not required by all embodiments, some embodiments employ a display template (or “template”) to display content based on a schema. Templates can implement various “views”. By way of illustration, views could be “full”, “thumbnail”, and “list” but additional “views” could be defined by end-users. A full view can be the largest, or full page view of the content. A thumbnail view would be a very small view and a list view can be used when displaying multiple content nodes as a “list” on the page (e.g., a product catalog search results page). In various embodiments, the association between a schema and templates can be one-to-many. A template can be designated as the default template for a schema. In certain of these embodiments, templates can be designed with the aid of an integrated development environment (IDE). It is noteworthy that template technology is not limited to web applications. Other delivery mechanisms such as without limitation mobile phones, XML, and the like can be enabled by this technology.

In various embodiments and by way of illustration, display templates can be implemented using HTML (Hypertext Markup Language) and JSP (Java® Server Pages). By way of a further illustration, such a display template can be accessed from a web page through a JSP tag that can accept as an argument the identifier of a content node. Given the content node, the node's schema and associated default display template can be derived and rendered. Alternatively, the JSP tag can take an additional argument to specify a view other than the default. In another embodiment, display templates can be automatically generated (e.g., beforehand or dynamically at run-time) based on a content node's schema. In other embodiments, the view (e.g., full, thumbnail, list) can be determined automatically based on the contents of an HTTP request.

In various embodiments, a role is a dynamic set of users. By way of illustration, a role can be based on functional responsibilities shared by its members. In aspects of these embodiments, a role can be defined by one or more membership criteria. Role mapping is the process by which it is determined whether or not a user satisfies the membership criteria for a given role. For purposes of discussion, a role can be described as follows:

Role=PMembers+[Membership Criteria]

where PMembers is a set of user(s), group(s) and/or other role(s) that form a pool of potential members of this role subject to the Membership Criteria, if any. A user or a process can be in a role, if that user or process belongs to PMembers or satisfies the Membership Criteria. It is noteworthy that a user or process does not need to be a member of PMembers to be considered a member of the role. For example, it is possible to define a role with a criterion such as: “Only on Thursdays” as its membership criteria. All users would qualify as a member of this role on Thursdays. The Membership Criteria can include one or more conditions. By way of illustration, such conditions can include, but are not limited to, one or more (possibly nested and intermixed) Boolean, mathematical, functional, relational, and/or logical expressions. By way of illustration, consider the following Administrator role:

Administrator=Joe, Mary, SuperUser+CurrentTime>5:00 pm

The role has as its potential members two users (Joe and Mary) and users belonging to the user group named SuperUser. The membership criteria includes a condition that requires the current time to be after 5:00 pm. Thus, if a user is Joe, Marry or belongs to the SuperUser group, and the current time is after 5:00 pm, the user is a member of the Administrator role.

In various embodiments, roles can be associated with Resource(s). By way of illustration, a resource can be any system and/or application asset (e.g., VCR nodes and node properties, VCR schemas and schema properties, operating system resources, virtual machine resources, J2EE application resources, and any other entity that can be used by or be a part of software/firmware of some kind). Typically, resources can be arranged in one or more hierarchies such that parent/child relationships are established (e.g., the VCR hierarchical namespace and the schema inheritance hierarchy). In certain of these embodiments, a containment model for roles is followed that enables child resources to inherit roles associated with their parents. In addition, child resources can override their parents' roles with roles of their own.

In various embodiments, Membership Criteria can be based at least partially on a node's properties. This allows for roles that can compare information about a user/process to content in the VCR, for example. In various embodiments, a node's property can be programmatically accessed using dot notation: Article.Creator is the Creator property of the Article node. By way of illustration, assume an Article node that represents a news article and includes two properties: Creator and State. A system can automatically set the Creator property to the name of the user that created the article. The State property indicates the current status of the article from a publication workflow standpoint (e.g., whether the article is a draft or has been approved for publication). In this example, two roles are defined (see Table 2).

TABLE 2
Exemplary Roles in an Embodiment

| ROLE | ASSOCIATED | | MEMBERSHIP |
|---|---|---|---|
| NAME | WITH | PMEMBERS | CRITERIA |
| Submitter | Article | Article.Creator | Article.State = Draft |
| Approver | Article | Editor | Article.State = (Submitted |
| | | | or Approved) |

The Submitter and Approver roles are associated with the Article node. Content nodes instantiated from this schema will inherit these roles. If a user attempting to access the article is the article's creator and the article's state is Draft, the user can be in the Submitter role. Likewise, if a user belongs to an Editor group and the article's state is Submitted or Approved, then the user can belong to the Approver role.

In various embodiments, a policy can be used to determine what capabilities or privileges for a given resource are made available to the policy's Subjects (e.g., user(s), group(s) and/or role(s)). For purposes of discussion, a policy can be described as follows:

Policy=Resource+Privilege(s)+Subjects+[Policy Criteria]

Policy mapping is the process by which Policy Criteria, if any, are evaluated to determine which Subjects are granted access to one or more Privileges on a Resource. Policy Criteria can include one or more conditions. By way of illustration, such conditions can include, but are not limited to, one or more (possibly nested and intermixed) Boolean, mathematical, functional, relational, and/or logical expressions. Aspects of certain embodiments allow policy mapping to occur just prior to when an access decision is rendered for a resource.

Similar to roles, in certain of these embodiments a containment model for policies is followed that enables child resources to inherit policies associated with their parents. In addition, child resources can override their parents' polices with policies of their own.

In various embodiments, policies on nodes can control access to privileges associated with the nodes. By way of illustration, given the following policies:

Policy1 = Printer504 + Read/View + Marketing
Policy2 = Printer504 + All + Engineering

the Marketing role can read/view and browse the Printer504 resource whereas the Engineering role has full access to it (“All”). These privileges are summarized in Table 3. Policy1 allows a user in the Marketing role to merely view the properties of Printer504 whereas Policy2 allows a user in the Engineering role to view and modify its properties, to create content nodes based on Printer504 (assuming it is a schema), and to delete the resource.

TABLE 3
Exemplary Privileges for a “Printer504”
Node in Various Embodiments

| | | READ/ | | | |
|---|---|---|---|---|---|
| ROLE | CREATE | VIEW | UPDATE | DELETE | BROWSE |
| Marketing | | x | | | x |
| Engineering | x | x | x | x | x |

Aspects of certain of these embodiments include an implied hierarchy for privileges wherein child privilege(s) of a parent privilege are automatically granted if the parent privilege is granted by a policy.

In various embodiments, the containment models for polices and roles are extended to allow the properties of a node to inherit the policies and roles that are incident on the node. Roles/polices on properties can also override inherited roles/polices. For purposes of illustration, assume the following policy on a Power property of Printer504:

Policy3=Printer504.Power+Update+Marketing

In Policy3, the Marketing role is granted the right to update the Power property for the printer resource Printer504 (e.g., control whether the printer is turned on or off). By default, the Read/View property is also granted according to an implied privilege hierarchy. (There is no Browse privilege for this property.) See Table 4. Alternatively, if there was no implied privilege hierarchy, the Power property would inherit the read/view privilege for the Marketing role from its parent, Printer504. Although no policy was specified for the Power property and the Engineering role, the privileges accorded to the Engineering role can be inherited from a parent node. These privileges are summarized in Table 4.

TABLE 4
Exemplary Privileges for the “Power” Property
in the “Printer504” Node

| ROLE | CREATE | READ/VIEW | UPDATE | DELETE |
|---|---|---|---|---|
| Marketing | | x | X | |
| Engineering | X | x | X | x |

In various embodiments, the ability to instantiate a node based on a schema can be privileged. This can be used to control which types of content can be created by a user or a process. By way of illustration, assume the following policy:

Policy4=Press_Release+Instantiate+Marketing, Manager

Policy4 specifies that nodes created based on the schema Press_Release can only be instantiated by users/processes who are members of the Marketing and/or Manager roles. In aspects of certain of these embodiments, user interfaces can use knowledge of these policies to restrict available user choices (e.g., users should only be able to see and choose schemas on which they have the Instantiate privilege).

In various embodiments, policies can be placed on schemas. For purposes of illustration, assume the following policies:

Policy5 = Press_Release + Read/View + Everyone
Policy6 = Press_Release + All + Public_Relations

TABLE 5
Exemplary Privileges for the “Press Release” Schema

| | CREATE | READ/ | | | |
|---|---|---|---|---|---|
| ROLE | INSTANCE | VIEW | UPDATE | DELETE | BROWSE |
| Everyone | | X | | | x |
| Public | x | X | x | x | x |
| Relations | | | | | |

With reference to Table 5 and by way of illustration, assume a content node instance was created based on the Press Release schema. By default, it would have the same roles/polices as the Press Release schema. If a policy was added to the node giving a role “Editor” the privilege to update the node, the result would be additive. That is, Everyone and Public Relations would maintain their original privileges.

In various embodiments, policies can be placed on properties within a schema, including property choices. (Property choices are a predetermined set of allowable values for a given property. For example, a “colors” property could have the property choices “red”, “green” and “blue”.)

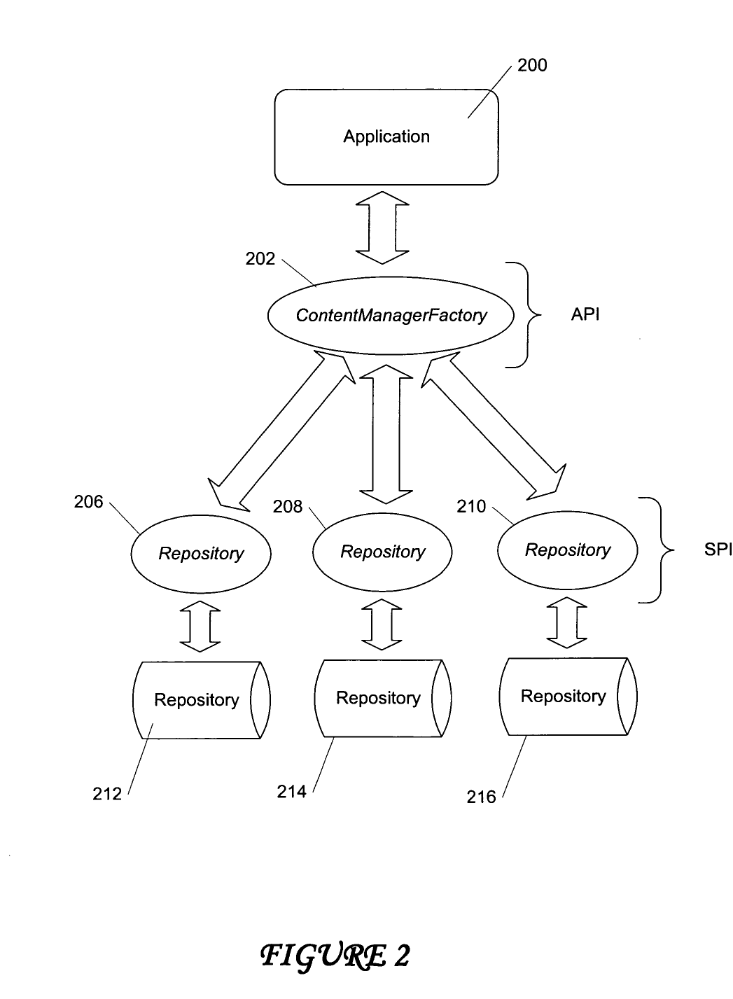

FIG. 2 is an exemplary illustration of objects/interfaces that can be used to interface repositories comprising content in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

The ContentManagerFactory 202 can serve as a representation of an access device from an application program's 200 point of view. In aspects of these embodiments, the ContentManagerFactory attempts to connect all available repositories to the device (e.g., 212-216); optionally with user or process credentials. In various embodiments, this can be based on the Java™ Authentication and Authorization Service (available from Sun Microsystems, Inc.). Those of skill in the art will recognize that many authorization schemes are possible without departing from the scope and spirit of the present disclosure. Each available content repository is represented by an SPI Repository object 206-210. In an embodiment, the ContentManagerFactory can invoke a connect( ) method on the set of Repository objects. Alternatively, in some embodiments, the notion of “connecting” to a repository is not exposed to users. In various embodiments, the ContentManagerFactory returns a list of repository session objects to the application program, one for each repository for which a connection was attempted. Any error in the connection procedure can be described by the session object's state. In another embodiment, the ContentManagerFactory can connect to a specific repository given the repository name. In various embodiments, the name of a repository can be a URI (uniform resource identifier).

Type Inheritance

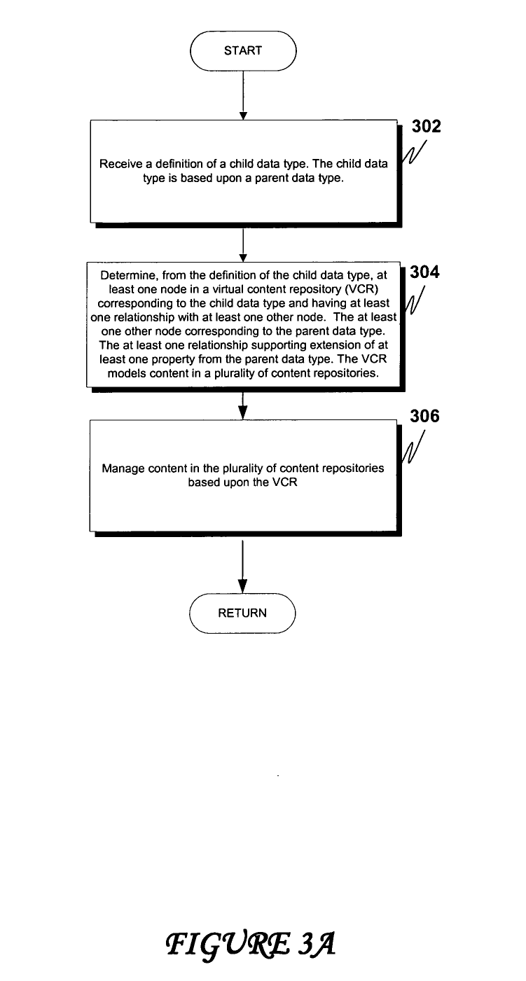

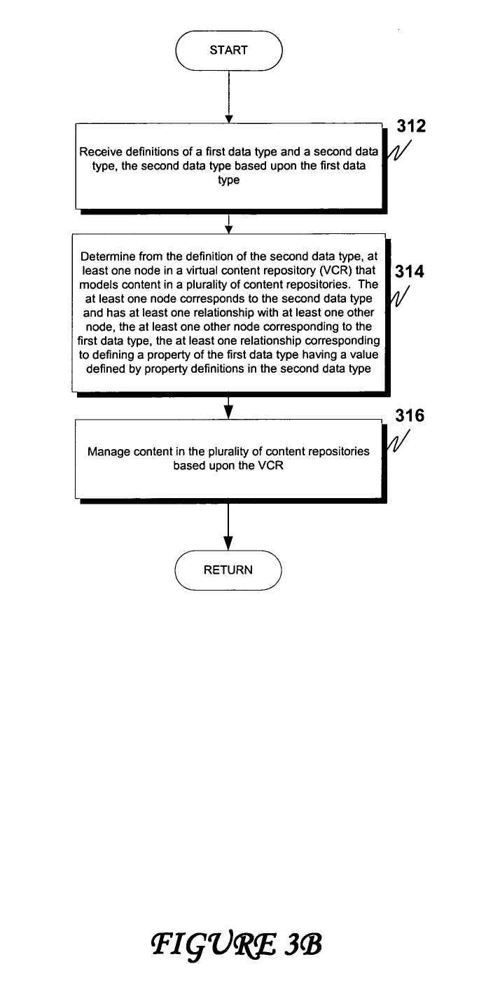

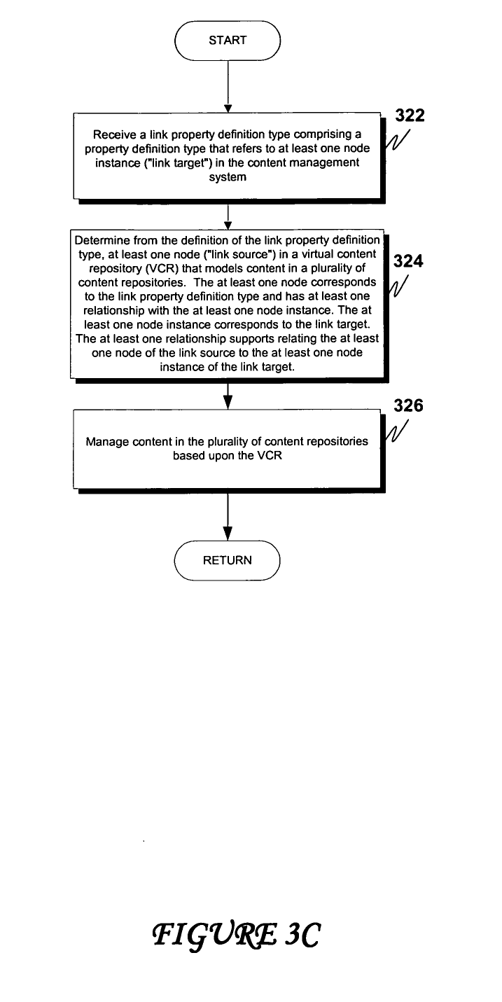

FIG. 3A is an operational flow diagram illustrating a high level overview of a technique for type inheritance in a content management system in an embodiment. As shown in FIG. 3A, a definition of a child data type is received (block 302). The child data type can be based upon a parent data type. One or more nodes in a virtual content repository (VCR) may be determined from the definition of the child data type (block 304). The node(s) correspond to the child data type and have at least one relationship with at least one other node. At least one other node corresponds to the parent data type. The at least one relationship supports extension of at least one property from the parent data type. The VCR models content in a plurality of content repositories. Content in the plurality of content repositories is managed (block 306) based upon the VCR.

In some embodiments, type Inheritance is limited to within the context of a single repository. In some embodiments, a static inheritance model is enforced. In other words, nodes of a type will have the same properties. In some embodiments, a singular model having unlimited depth is enforced. In other words, the inheritance model supports chain types: a→b→c→ . . . →z and so on. In some embodiments, a given type is restricted to inheriting from a single parent. In some embodiments, cyclical inheritance chains are blocked. In other words, an inheritance chain such as A→B→A cannot be formed. In some embodiments, an attempt to create a property definition by the child type with the same name as a parent type is blocked. In some embodiments, a child type is enabled to overload a given property definition. In some embodiments, retrieval of a node of a subtype does not require knowledge of the type's structure. Rather, this can be obtained by interrogating the type object. In some embodiments, when a user requests all nodes of a given type, nodes of the specified type and those of types that extend the specified type are returned. In some embodiments, nodes are prevented from being “downcast”. In other words, if a user has an instance of a subtype, the node will behave like the subtype, not as an instance of the parent type. In some embodiments, the nodes are blocked from determining which properties are inherited from other types from which the nodes were instantiated. This can make the inheritance concept is transparent to nodes. Some embodiments support type security for each type and/or versioning of nodes.

The following scenario illustrate operation of an embodiment providing abstract data types:
A user creates a type and at creation time indicates that the type is abstract. The abstract modifier is simply a boolean flag.
The user then attempts to create a node from the abstract type. This operation should fail with indication that an instance of an abstract type is illegal.

The following scenario illustrate operation of an embodiment providing abstract data type updating:
A user creates an abstract type.
The user updates the type to disable the abstract modifier.
The user is then able to create instances of this type.

The following scenario illustrates operation of an embodiment providing detection that an abstract data type is not abstract:
A user creates a type—not specifying the abstract modifier. By default behavior the type is not abstract.
The user creates an instance of this type.
The user attempts to make the type abstract, with instances of the type in existence. This operation fails with indication that a type cannot be made abstract while it has instances.
All instances of the type are then removed.
The type can then be modified to become abstract.

The following scenario illustrates operation of an embodiment providing abstract data type removal:
A user creates an abstract type.
The user is free to remove this type at any time unless it is a supertype (and therefore engaged in type inheritance) or it is a nested type within another type. When the inheritance relationship is broken and the abstract type is no longer a supertype to another type, then it may be freely removed.

The following scenario illustrates operation of an embodiment providing abstract data type inheritance:
A user creates an abstract type.
The type may be used as a base type for inheritance. No behavior is implied by the selection of an abstract type as a base type. The abstract type's behavior does not change in being used as a base type, aside from the fact that it cannot be removed if a subtype has any instances.

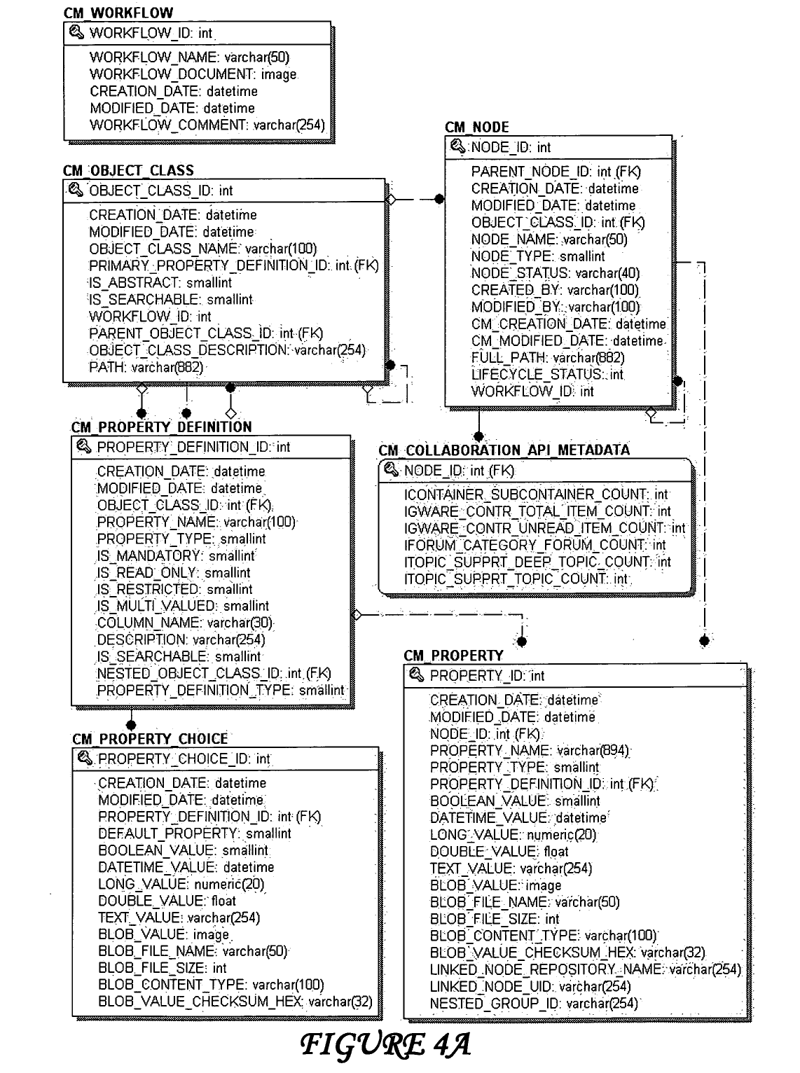

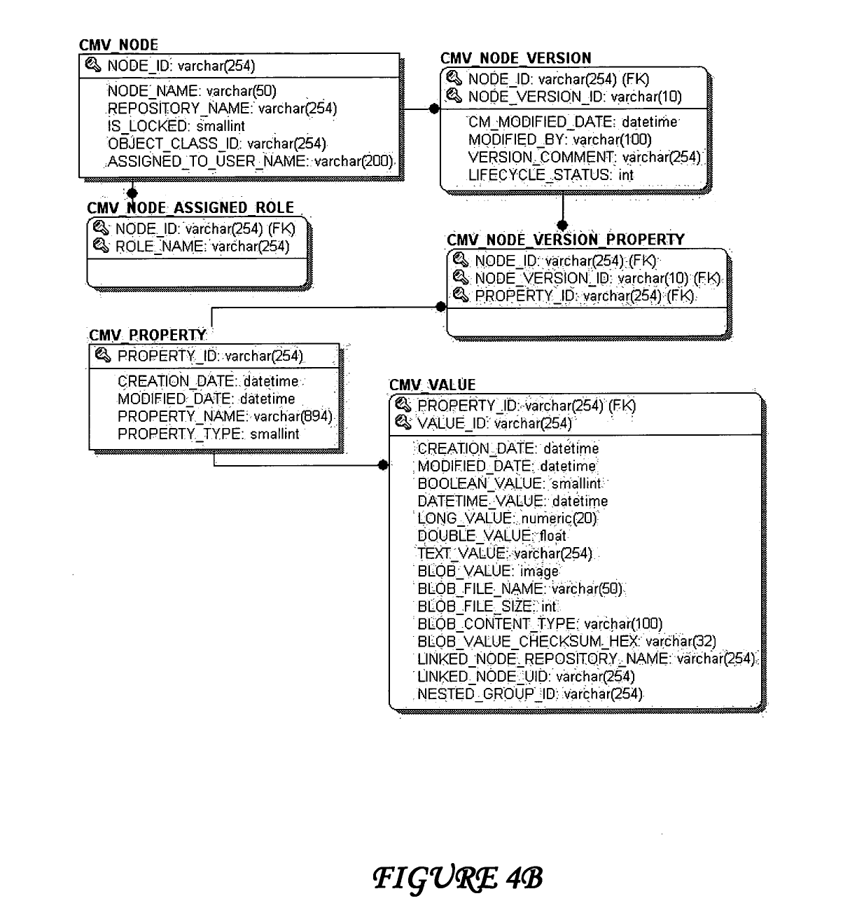

FIGS. 4A-4B are data diagrams illustrating database fields and relationships supporting inheritance of types, nested types and link property types in an embodiment. In FIG. 4A, IS_ABSTRACT (BOOLEAN), PARENT_OBJECT_CLASS_ID (LONG, NULL) and PATH (VARCHAR, NULL) columns are added to a CM_OBJECT_CLASS. A PROPERTY_DEFINITION_TYPE (INT) is added to a CM_PROPERTY_DEFINITION.

Nested Types

FIG. 3B is an operational flow diagram illustrating a high level overview of a technique for nested types in a content management system in an embodiment. As shown in FIG. 3B, definitions of a first data type and a second data type are received (block 312). The second data type based upon the first data type. At least one node is determined (block 314) from the definition of the second data type in a virtual content repository (VCR) that models content in a plurality of content repositories. The at least one node corresponds to the second data type and has at least one relationship with at least one other node. The at least one other node corresponds to the first data type. The at least one relationship corresponds to defining a property of the first data type having a value defined by property definitions in the second data type. Content in the plurality of content repositories is managed (block 316) based upon the VCR.

In some embodiments, nesting is limited to within the context of a single repository. In some embodiments, a model having unlimited depth is enforced. In other words, a user could model a type that nests another type that nests another type and so on. In some embodiments, cyclical nesting chains are blocked. In other words, a user is not allowed to model a “type A” which contains “type B” which contains “type C” which in turn contains “type A”.

In some embodiments, nested instances are treated as “contained” nodes for the purpose of exposure in the API. In other words, embodiments return a node or some other structure that represents the set of property values that make up the “contained node” when a user invokes a method for a property that returns a nested type.

In some embodiments, properties may be updated by building the nested hierarchy. In some embodiments, nested instances are managed explicitly by their containing instances. There is no representation to the user that a nested instance exists outside of the containing instance. In some embodiments, a nested type and/or a container type cam be abstract types. In some embodiments, it is possible to have more than one instance of the nested type, i.e., the type is multivalued.

In some embodiments, any type can have a primary property definition defined. If that type gets nested within another type, the primary property definition has no affect on the container type. The container type is limited to understanding a primary property definition defined for that particular type, but not for any of the nested types. A nested type in a container type can have one or more of the following primary property definitions:
Property Name—Property definitions of container and nested types don't interrelate and therefore no restriction on their names apply. It is perfectly legal to have a “name” property definition in both a container type and within a type the container nests.
Property Type—Represented as a nested property type.
Mandatory—Allowed.
Read Only—Not allowed (though property definitions w/in the nested type can be read only).
Restricted—Not allowed. When a user selects the “nested type” for a property definition, they may not specify a property choice (and therefore a default value) for the nested instance.
Multi Valued—More than one instance of the nested type permitted.
Column Name—Not allowed.

A container type can have the following property definitions for CRUD operations:
For the container type property definition (that represents the nested type, ie homeAddress), all CRUD actions are allowable except for column name or restriction (which make no sense to have defined for a nested type).
For the nested type property definitions—the same update and delete rules apply as for property definitions that haven't been nested, except the presence of the instances/nodes for the nested and container types is checked.

In some embodiments, a containing type property returns the nested type instance as a Property with a Value of java type Property[ ], called nestedValue. Specifically, when a property is obtained from a node that represents a nested type (i.e, homeAddress), a Property with a Value that has been instantiated as a Property[ ] containing all of the values for each property defined in the address type, will be returned.

In some embodiments, type level security and node level security are provided. In type level security, READ capability of the nested type is required to create the containment association. Further, a user without READ capability on a nested type cannot read the container type. In node level security, CCI of container and all nested types is required.

In some embodiments, nested types can be searched. For example, a search for City=“Boulder” returns all nodes with a PD name of “City” with a value of “Boulder”, regardless of type.

In some embodiments, nested types can interact with other type features. For example:
Polymoprhism of nested types is disallowed.
Types may be nested at any level (parent, child, etc)
Any nested type may be inherited

The following scenario illustrate operation of an embodiment providing abstract type nested:
A user creates an abstract type.
The type may be used as a nested type. No behavior is implied by the selection of an abstract type as a nested type. The abstract type's behavior does not change in being used as a nested type, aside from the fact that it cannot be removed if a container type has any instances.

FIGS. 4A-4B are data diagrams illustrating database fields and relationships supporting inheritance of types, nested types and link property types in an embodiment. In FIG. 4A, a column NESTED_OBJECT_CLASS_ID (of type NUMBER, to be a FK to CM_OBJECT_CLASS) is added to the CM_PROPERTY_DEFINITION table. The PROPERTY_NAME in the CM_PROPERTY table is altered to be about 900 chars wide and a column NESTED_GROUP_ID (of type VARCHAR(254) null) is added. In FIG. 4B, the PROPERTY_NAME in the CMV_PROPERTY table is altered to be about 900 chars wide.

Link Property Types

FIG. 3C is an operational flow diagram illustrating a high level overview of a technique for link property types in a content management system in an embodiment. As shown in FIG. 3C, a link property definition type comprising a property definition type that refers to at least one node instance (“link target”) in the content management system is received (block 322). At least one node (“link source”) is determined from the definition of the link property definition type in a virtual content repository (VCR) that models content in a plurality of content repositories (block 324). The at least one node corresponds to the link property definition type and has at least one relationship with the at least one node instance. The at least one node instance corresponds to the link target. The at least one relationship supports relating the at least one node of the link source to the at least one node instance of the link target. Content in the plurality of content repositories is managed (block 326) based upon the VCR. It is noteworthy that link sources can target multiple link target nodes.

In some embodiments, a link target can refer to any node in the repository regardless of ObjectClass type, or whether or not it is a content or hierarchy node. In some embodiments, there is no limit to the number of link property definitions that can be placed on a given type. In some embodiments, a link property definition type will not permit the creation of property choices and therefore default values for the property.

In some embodiments, when a method to retrieve a property is invoked on the node to retrieve the link property value, the following processing will occur:
If the target node exists, the target node will be retrieved.
If the target node has not yet been specified, the getProperty( ) method will return null.
If the target node has been specified, but does not exist, an exception type that extends RepositoryException will be thrown.

In some embodiments, a node which other nodes have as a link property target can be deleted. In some embodiments, existence of a link property target node is verified when a method for setting a property is invoked. In some embodiments, if the link target node is not null and the node does not exist, an exception will be thrown. In some embodiments, a node's properties may be versioned, but versioning is not performed on any nodes to which a link property refers. In some embodiments, linked property types cannot be used in search.

FIGS. 4A-4B are data diagrams illustrating database fields and relationships supporting inheritance of types, nested types and link property types in an embodiment. In FIG. 4A, a LINKED_NODE_UID column (FK to CM_NODE) is added to CM_PROPERTY. In FIG. 4B, a LINKED_NODE_UID column (FK to CM_NODE) is added to CMV_VALUE.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for type inheritance, nested types and link property types in a content management system as discussed herein.

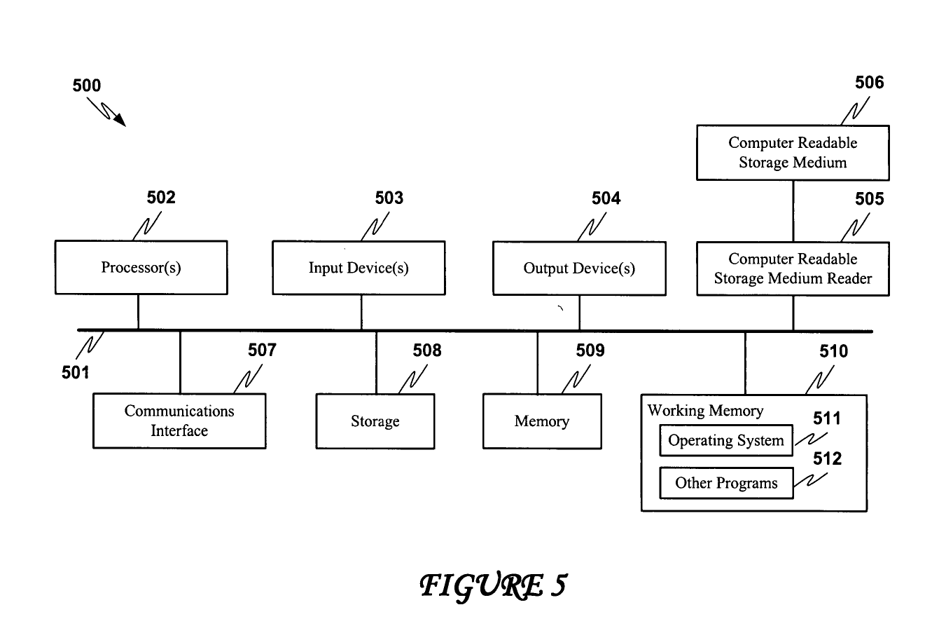

FIG. 5 illustrates an exemplary processing system 500, which can comprise one or more of the elements of FIG. 1. Turning now to FIG. 5, an exemplary computing system is illustrated that may comprise one or more of the components of FIG. 1. While other alternatives might be utilized, it will be presumed for clarity sake that components of the systems of FIG. 1 are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a machine readable storage media reader 505 coupled to a machine readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for type inheritance in a content management system, the method comprising:
receiving a definition of a child data type, the child data type based upon a parent data type;
determining, from the definition of the child data type, at least one node in a virtual content repository (VCR) corresponding to the child data type and having at least one relationship with at least one other node, the at least one other node corresponding to the parent data type, the at least one relationship supporting extension of at least one property from the parent data type to the child data type; wherein the VCR models content in a plurality of content repositories; and
managing content in the plurality of content repositories based upon the VCR.

2. The method of claim 1, wherein determining, from the definition of a child data type, at least one node in a virtual content repository (VCR) corresponding to the child data type and having at least one relationship with at least one other node, the at least one other node corresponding to the parent data type includes:
determining that at least one of the parent type definition and the child type definition is an abstract data type; and
blocking instantiation of any nodes based upon the abstract data type.

3. The method of claim 1, wherein determining, from the definition of a child data type, at least one node in a virtual content repository (VCR) corresponding to the child data type and having at least one relationship with at least one other node, the at least one other node corresponding to the parent data type includes:
providing a capability to limit type inheritance to within a single repository.

4. The method of claim 1, wherein determining, from the definition of a child data type, at least one node in a virtual content repository (VCR) corresponding to the child data type and having at least one relationship with at least one other node, the at least one other node corresponding to the parent data type includes:
enforcing a static inheritance model in which nodes of a type will have the same properties.

5. The method of claim 1, wherein determining, from the definition of a child data type, at least one node in a virtual content repository (VCR) corresponding to the child data type and having at least one relationship with at least one other node, the at least one other node corresponding to the parent data type includes:
enforcing a singular inheritance model with unlimited depth.

6. The method of claim 1, wherein determining, from the definition of a child data type, at least one node in a virtual content repository (VCR) corresponding to the child data type and having at least one relationship with at least one other node, the at least one other node corresponding to the parent data type includes:
restricting a child type to inherit only from a single parent type.

7. The method of claim 1, wherein determining, from the definition of a child data type, at least one node in a virtual content repository (VCR) corresponding to the child data type and having at least one relationship with at least one other node, the at least one other node corresponding to the parent data type includes:
blocking attempting to create a cyclical inheritance chain.

8. The method of claim 1, wherein determining, from the definition of a child data type, at least one node in a virtual content repository (VCR) corresponding to the child data type and having at least one relationship with at least one other node, the at least one other node corresponding to the parent data type includes:
blocking attempting to create a property definition in the child type of same name as a parent type.

9. The method of claim 1, wherein determining, from the definition of a child data type, at least one node in a virtual content repository (VCR) corresponding to the child data type and having at least one relationship with at least one other node, the at least one other node corresponding to the parent data type includes:
enabling the child type to overload a property defined as a portion of the parent type.

10. The method of claim 1, wherein determining, from the definition of a child data type, at least one node in a virtual content repository (VCR) corresponding to the child data type and having at least one relationship with at least one other node, the at least one other node corresponding to the parent data type includes:
retrieving a node of the child type without knowledge of the type's structure by interrogating a type object.

11. The method of claim 1, wherein determining, from the definition of a child data type, at least one node in a virtual content repository (VCR) corresponding to the child data type and having at least one relationship with at least one other node, the at least one other node corresponding to the parent data type includes:
returning nodes of a specified type and of types that extend the specified type when a user requests all nodes of a given type.

12. The method of claim 1, wherein determining, from the definition of a child data type, at least one node in a virtual content repository (VCR) corresponding to the child data type and having at least one relationship with at least one other node, the at least one other node corresponding to the parent data type includes:
preventing downcasting by enforcing that a node that is an instance of a child type behaves like the child type, not as an instance of the parent type.

13. The method of claim 1, wherein managing content in the plurality of content repositories based upon the VCR includes:
extending the at least one property from the parent data type to the child data type for operations on the at least one node in the VCR corresponding to the child data type or on the at least one node in the VCR corresponding to the parent data type.

14. A machine-readable medium carrying one or more sequences of instructions for type inheritance in a content management system, which instructions, when executed by one or more processors, cause the one or more processors to carry out the steps of:
receiving a definition of a child data type, the child data type based upon a parent data type;
determining, from the definition of the child data type, at least one node in a virtual content repository (VCR) corresponding to the child data type and having at least one relationship with at least one other node, the at least one other node corresponding to the parent data type, the at least one relationship supporting extension of at least one property from the parent data type to the child data type; wherein the VCR models content in a plurality of content repositories; and
managing content in the plurality of content repositories based upon the VCR.

15. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
determining that at least one of the parent type definition and the child type definition is an abstract data type; and
blocking instantiation of any nodes based upon the abstract data type.

16. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
providing a capability to limit type inheritance to within a single repository.

17. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
enforcing a static inheritance model in which nodes of a type will have the same properties.

18. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
enforcing a singular inheritance model with unlimited depth.

19. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
restricting a child type to inherit only from a single parent type.

20. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
blocking attempting to create a cyclical inheritance chain.

21. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
blocking attempting to create a property definition in the child type of same name as a parent type.

22. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
enabling the child type to overload a property defined as a portion of the parent type.

23. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
retrieving a node of the child type without knowledge of the type's structure by interrogating a type object.

24. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
returning nodes of a specified type and of types that extend the specified type when a user requests all nodes of a given type.

25. The machine-readable medium as recited in claim 14, wherein the instructions for carrying out the step of determining, from the definition of a child data type, at least one node in a virtual content repository (VCR) corresponding to the child data type and having at least one relationship with at least one other node, the at least one other node corresponding to the parent data type include instructions for carrying out the step of:
preventing downcasting by enforcing that a node that is an instance of a child type behaves like the child type, not as an instance of the parent type.

26. The machine-readable medium as recited in claim 14, wherein the instructions for carrying out the step of managing content in the plurality of content repositories based upon the VCR include instructions for carrying out the step of:
extending the at least one property from the parent data type to the child data type for operations on the at least one node in the VCR corresponding to the child data type or on the at least one node in the VCR corresponding to the parent data type.

27. An apparatus for type inheritance in a content management system, the apparatus comprising:
a processor; and
one or more stored sequences of instructions which, when executed by the processor, cause the processor to carry out the steps of:
receiving a definition of a child data type, the child data type based upon a parent data type;
determining, from the definition of the child data type, at least one node in a virtual content repository (VCR) corresponding to the child data type and having at least one relationship with at least one other node, the at least one other node corresponding to the parent data type, the at least one relationship supporting extension of at least one property from the parent data type to the child data type; wherein the VCR models content in a plurality of content repositories; and
managing content in the plurality of content repositories based upon the VCR.

28. A method for sending code through a transmission medium, comprising:
transmitting code to receive a definition of a child data type, the child data type based upon a parent data type;
transmitting code to determine, from the definition of the child data type, at least one node in a virtual content repository (VCR) corresponding to the child data type and having at least one relationship with at least one other node, the at least one other node corresponding to the parent data type, the at least one relationship supporting extension of at least one property from the parent data type to the child data type; wherein the VCR models content in a plurality of content repositories; and
transmitting code to manage content in the plurality of content repositories based upon the VCR.
